(19) United States
(12) Patent Application Publication
(10) Pub. No.: US 2008/0092590 A1
(43) Pub. Date: Apr. 24, 2008

(54) Reversible Absorption Refrigeration

(75) Inventor: James D. Yearout, San Pedro, CA (US)

Correspondence Address: JEFFER, MANGELS, BUTLER & MARMARO, LLP, 1900 AVENUE OF THE STARS, 7TH FLOOR, LOS ANGELES, CA, 90067, US

(73) Assignee: ENERGY RESOURCES GROUP LLC, San Pedro, CA (US)

(21) Appl. No.: 11/577,398

(22) PCT Filed: Jun. 29, 2005
(86) PCT No.: PCT/US05/23389

§ 371 Date: Apr. 17, 2007

Related U.S. Application Data
(60) Provisional application No. 60/584,285, filed on Jun. 30, 2004.

(51) Int. Cl. F25B 15/04; C09K 5/00; F25B 17/00; F25J 3/00; C09K 5/04

(52) U.S. Cl. 62/643; 62/101; 62/478

(57) ABSTRACT

A non-adiabatic distillation (NAD) process has been developed which combines the required heat transfer and mass transfer required for the separation of a mixture with the mass transfer, resulting in a more reversible, and therefore more energy efficient process. This distillation process, when used in conjunction with ammonia absorption refrigeration systems, allows for feasible and cost-effective production of refrigeration from low-grade waste heat. The primary advantage of the NAD process is its ability to efficiently utilize sensible heat contained in gases resulting from combustion processes. Thermal energy is converted to refrigeration with exhaust gas temperatures as low as 80° C.

### CROSS REFERENCE TO RELATED APPLICATIONS

This application claims the benefit of U.S. Provisional Application No. 60/584,285.

### FIELD OF THE INVENTION

The present invention relates to improved refrigeration systems, more particularly to a reversible absorption system employing non-adiabatic distillation for utilizing low-grade waste heat.

### BACKGROUND OF THE INVENTION

Recent volatility in both the price and reliability of electric power and in basic energy sources suggests the need for reliable energy generation alternatives. Businesses operating in marketplaces where electric power is sold at premium prices are looking for ways to make efficient use of waste heat in order to lower operating costs. Current methods for putting waste heat to use include producing refrigeration using classic ammonia or lithium bromide absorption refrigeration systems (ARSs).

The supermarket is an excellent example of a business which would benefit from an efficient ARS, as it has heavy refrigeration loads associated with storing and displaying fresh and frozen produce. Another example is a computer server farm, in which the heat generated by almost constantly running computers must be dissipated by reliable air conditioning equipment. However, businesses tend to disfavor ARSs, as these systems are characterized by high capital cost and higher energy consumption per unit of refrigeration capacity than vapor compression cycle competition. Furthermore, because of performance limitations on current ARSs, these systems are often not able to fully support the refrigeration loads of businesses. Businesses using these systems must then purchase electric driven compression from the power grid or install additional generator capacity. In regions where the power grid is unreliable, additional generation capacity is the only rational solution.

Current practice attempts to recover thermal energy outside of the mass transfer zones. Large sums of money have been spent on ammonia absorption refrigeration systems that improve the C.O.P.; the improvement is called “Generator Absorber Exchange” (GAX), which does recover some heat of absorption. However, this attempt is placed in the wrong process location. The use of a heat exchange device to heat the rich solution with a mixture of the lean solution and ammonia vapor introduces the vapor at the opposite end of the device from the place where the lean solution enters. The reversible ammonia refrigeration system uses an ejector to mix the ammonia vapor stream with the cooled stripping column bottoms liquid. The ejector will act as a vacuum pump to draw the vapor into intimate contact with the liquid. Absorption of the ammonia into the water will cause the temperature to rise, until the mixture reaches equilibrium. Using this mixture, immediately following the ejector (to make most effective use of the thermal energy resulting from the heat of absorption), results in a superior C.O.P., when compared to any of the present practice concepts.

The advantage to ammonia ARSs lies in their ability to use a very low grade of thermal energy. Furthermore, the system itself is a low maintenance, long-lived machine consisting of a minimum of lightly loaded mechanical parts. Ammonia ARSs, for example, are known to last for as long as 50 years.

One drawback of current ammonia ARSs is that they require that all thermal energy be above the highest temperature required by the distillation process, which is typically about 180° C. This restriction limits the usefulness of the ammonia ARS. Allowing the ammonia concentration to rise in the bottoms is the usual way to utilize lower grades of steam. However, this leads to increased solution pump flow rates which cause absorber physical size problems and also increase the capital cost, mainly due to the need for increased heat transfer surface.

The principle competitor for the ammonia ARS is the lithium bromide ARS, which has lower annual operating costs. A single-effect LiBr ARS is able to use lower grades of waste heat than the classical ammonia systems. The single effect Lithium Bromide Absorption Refrigeration System has a lower COP (Coefficient of Performance) than the classic Ammonia Absorption designs. The LiBr Double Effect has a COP of 1.2 (greater than the Ammonia cycle), but requiring at least the same temperature profile as the classic Ammonia cycle. All LiBr systems are limited on the refrigerant side to a minimum of 6° C., making the system unusable in food preservation applications. Furthermore, the LiBr ARS suffers from corrosion, having a maximum operating life of approximately 15 years. This system is also limited by its ability to accommodate only one evaporator, therefore being able to deliver refrigeration at only one temperature and is unable to cool below 6° C. In contrast, the ammonia ARSs can accommodate multiple evaporators and therefore can deliver refrigeration at several temperature levels.

Procedures have been described for analyzing multi-stage ammonia absorption systems. The most prominent of these is called the kangaroo cycle, which nests a classic ammonia absorption system inside another classic ARS. Substantial C.O.P gains are predicted; however, the presently disclosed process greatly enhances the kangaroo concept as well as other variations of the classic ammonia absorption system.

Because of operating cost considerations, ammonia ARSs have almost completely been replaced by LiBr systems. Still, the ammonia ARS has several advantages and could potentially be an efficient refrigeration system. For a single stage, or single-effect ammonia ARS, the coefficient of performance (C.O.P.) is generally quoted to be a practical maximum of 0.7 (0.7_{cold}/1.0ₕₑₐₜ). However, this limit on the C.O.P. is due to process design practices, not due to limitations on the basic thermodynamic process.

The theoretical work of separation for any mixture is usually defined as the reversible work required to isothermally compress each component of a mixture from its partial pressure in the mixture to the total pressure of the mixture, as shown by Equation 1:

$${\sum }_{i = 1 -> n} {W}_{rev , i} = RT * ln ( \frac{{P}_{2 i}}{{P}_{1 i}} ) \qquad ( Equation 1 )$$

Assuming a beginning 50:50 ammonia-water mixture, the theoretical reversible work is 42.3 kcal/kg. The latent heat of evaporation of ammonia is roughly 287 kcal/kg, so a theoretical maximum C.O.P. of 6.78 may be considered the upper limit. This places the Carnot efficiency of current practices in the region of 10%. Based on other well-developed thermodynamic processes, like stationary Diesel engines which have Carnot efficiencies of above 30%, a C.O.P. of better than 2 should be a realistic target for ammonia absorption refrigeration systems.

A key component of the ammonia absorption system is the distillation stage, where the ammonia is stripped from the feed mixture. Distillation systems are usually configured to add heat only at the bottom, and extract heat at the top of the column. The mass transfer takes place in an insulated, adiabatic zone. This separation of heat and mass transfer is the major source of irreversibility in the distillation process. Finding ways to decreasing the amount of irreversible work could increase the thermodynamic efficiency of the system.

It is therefore an object of the present invention to provide systems and methods for refrigeration which utilize low-grade waste heat more efficiently.

It is another object of the present invention to provide a non-adiabatic distillation process which more efficiently uses thermal energy.

### SUMMARY OF THE INVENTION

A non-adiabatic distillation (NAD) process has been developed which combines the required heat transfer and mass transfer required for the separation of a mixture with the mass transfer, resulting in a more reversible, and therefore more energy efficient process. This distillation process, when used in conjunction with ammonia absorption refrigeration systems, allows for feasible and cost-effective production of refrigeration from low-grade waste heat. The primary advantage of the NAD process is its ability to efficiently utilize sensible heat contained in gases resulting from combustion processes. Thermal energy is converted to refrigeration with exhaust gas temperatures as low as 80° C. This is a significant improvement on conventional ammonia absorption systems which require thermal energy at temperatures around 180° C. The NAD system is able to make use of thermal energy down to the bubble point of the ammonia-water feed to the column.

### BRIEF DESCRIPTION OF THE DRAWINGS

FIG. 1 is a process flow diagram of one embodiment of the ammonia ARS system utilizing non-adiabatic distillation.

FIG. 2 is a process flow diagram of one embodiment of the ammonia ARS system utilizing non-adiabatic distillation and recovered heat of absorption.

FIG. 3 is an illustration of the internal configuration of the stripping section of the non-adiabatic distillation column.

### DETAILED DESCRIPTION OF THE INVENTION

The general strategy for improving the energy efficiency of the ammonia ARS is to attack the sources of thermodynamic irreversibility in the distillation component. The greatest source of irreversibility in the distillation process is the separation of the heat and mass transfer components. Adding or subtracting heat within the column itself decreases the thermodynamic losses of the system due to irreversibility. The key to system performance is placing the recovered thermal energy where it is needed for maximum system performance.

Ammonia ARS Utilizing Non-Adiabatic Distillation

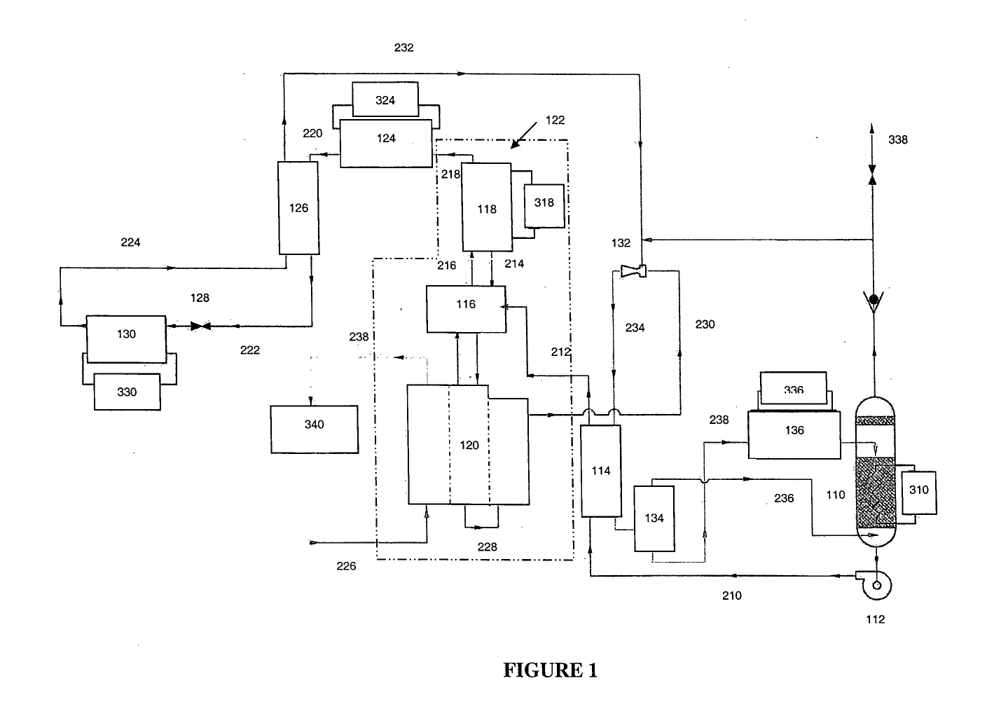

The first place to attack the problem of eliminating thermodynamic irreversibility is to recover the sensible heat from the nearly pure water in the bottoms of the stripping section. There is a temperature difference (ΔT) of approximately 150° F. between the bottoms and the feed, and recovery of this thermal energy within the boundary of the mass transfer operation results in the first major process improvement. The thermal energy of the hot liquid bottoms stream is recovered by cooling the stream in counter-flow heat exchange with the ammonia-water mixture in a suitable fractionating device. A reasonable ΔT of 5° F. at the cold end of the column is allowed to drive the heat transfer. This resulting ARS configuration produces approximately 2,000 BTUs of cooling for each 1,000 BTUs of thermal energy. FIG. 1 is a process flow diagram of a first embodiment of the NAD ammonia ARS.

While ammonia is environmentally friendly, and due to its universal use in agriculture, cheap and readily available anywhere, there are a number of other mixtures that can benefit from this approach. For example, most acid gases can be absorbed in aqueous solutions. Early U.S. electric household refrigerators, built by General Electric, used sulfur dioxide as a working fluid. Hydrocarbons, such as propane and butane, and their halocarbon homologues, are absorbed in higher molecular weight hydrocarbons, alcohols, ethers, and other solvents. Such fluids may be used for refrigeration in a petrochemical plant, for example.

Parameter Examples for Reversible Absorption Refrigeration

The limits are set for any system by the problem statement: in this case, a refrigeration system, the temperature at which the fluid is condensed, and the temperature at which it is evaporated. As the refrigerant is essentially pure ammonia, the vapor pressure curve of that fluid defines all other system boundaries. Once a condensing and an evaporating temperature (and therefore pressure) have been chosen, any process can be optimized for solution concentrations.

There is a wide set of operating parameters where the Non-Adiabatic Distillation approach will prove economically valuable. For example, ammonia absorption systems have been used in process applications with the evaporator working at a temperature of −60° F. A standard curve plotting ammonia vapor pressure against temperature, shows that the vapor pressure of ammonia drops below atmospheric pressure at −28° F., and that lower evaporator temperatures would require the absorber to operate under vacuum conditions. While much higher H₂O content in the circulating solution increases the solution pump flow requirements, it greatly simplifies the design of the absorber elements. Furthermore, a moderate and constant condensing temperature as well as a constant evaporator temperature will favor a high ammonia content in the circulating solution. Several examples can be found in unit operations in light petrochemical separations.

As another example, allowing the ammonia concentration in the hot bottoms liquid to rise has the effect of lowering the minimum temperature at which a waste heat stream can be utilized. This has the side effect of increasing the required solution circulation rate. Industrial engineering evaluation of the application will result in the optimum solution composition for those applications. Examples include food and pharmaceutical processing operations that are required to limit maximum temperatures in recycle loops to preserve product integrity.

Compositions likely to be observed in a specific system may be defined on the basis of the intended use of this invention where the available heat sink temperature varies over a wide range of operating conditions. One example is the use of air (air cooled condenser) as the heat sink in an environment where there are large variations in ambient air temperature. On a moderate day the pressure required in the evaporator will be relatively low, and the separation of the ammonia-water mixture in the stripping section is complete. On a very hot day, the pressure required in the condenser increases, and the separation of the binary mixture becomes more difficult. The temperature at bottom of the stripping section of the column will rise as a result of the increased column pressure, or the ammonia concentration in the bottoms liquid will increase.

If the system is expected to produce a constant amount of refrigeration (for example, electronic cooling applications), the system solution pump must be able to increase the flow rate of the rich liquor solution. A regenerative turbine pump with a variable speed drive is on method of accomplishing this process objective.

Further thermodynamic gains are available by staging ammonia absorption systems using the same logic used in double effect LiBr absorption cycles. Staging multiplies, by some factor, the C.O.P. of a single stage process loop, with the added expense of duplicated mechanical equipment requirements.

1. Absorber and Recuperator

Rich liquor 210 (approximately 50:50 molar ratio of ammonia to water, flows by gravity from the bottom of the absorber 110. Heat is dissipated from the absorber via a heat sink 310. The pressure at which the absorber operates is determined by the temperature desired in the evaporator 130. A solution pump 112 increases the pressure of the rich liquor to approximately 156 psia; however, changes in the feed composition, as well as the bottoms liquid composition, change the temperature profiles and liquid to vapor flow ratios in the system. The Ammonia vapor at the column overhead must remain the same very low water content, to avoid water freezing in the evaporator. As the Second Law of Thermodynamics prohibits a negative ΔT, a practical compromise is selected. Cryogenic systems often use designs of 1° F. as a practical economic value. The actual absolute temperature of the feed mixture is going to change with the temperature of the atmospheric heat sink. The rich liquor 210 enters the recuperator 114, which functions as a heat exchanger, where the liquor flows countercurrent with a hot stream of lean liquor 234. The rich liquor is heated to the boiling point of the mixture, for example, approximately 635° R for a 50:50 ammonia-water feed.

2. Manifold and Rectifying Section of Distillation Column

The saturated rich liquor 212, which optionally contain small amounts of vapor, is then directed to a manifold 116, which manages the direction of liquid 214 and vapor 216 streams to the rectifying section 118 and the non-adiabatic stripping section 120 of the separation column 122. The rectifying section of the column is operated similar to the way it is typically operated in the prior art. The rectifying section 118 acts as a partial condenser, such that water vapor in the mixture is condensed and flows by gravity back to the manifold 116. The temperature of the vapor 216 is above that of the atmospheric heat sink 318, so that the necessary heat transfer can be accomplished by natural convection. A portion of the cooling provided by the heat sink at 318 is normally provided by warming the stream of rich liquor at 210 prior to entering the recuperator, 114. Additional cooling, when required, comes from the ambient environment heat sink. The height of the rectifying section 118 should be great enough so that the saturated ammonia vapor 218 leaving the top of the column is essentially pure ammonia, for example, containing less than 0.1% by volume of water vapor.

3. Evaporator and Condenser Means

The evaporator-condenser loop is similar to that found in typical prior art ARSs. The saturated ammonia vapor 218 is directed to a condenser 124. Relatively pure ammonia will begin to condense at slightly above 543° R. The atmospheric heat sink 324 can be any suitable fluid which may be used to decrease the temperature of the condenser. The stream of rich liquor 210 will provide, at least, part of the duty of the heat sink 324. Examples include ocean or river water, cooling tower water, or ambient air. The pressure and temperature profile of the separation column 122 increase as the temperature of the heat sink 324 increases. The pressure must be high enough so that the heat sink 324 will condense pure ammonia. The saturated ammonia vapor 218 is almost completely condensed, exiting the condenser 124 as a liquid 220 preferably containing less than 1% vapor.

The liquid ammonia 220 enters the subcooler 126 where it is cooled below its boiling point by countercurrent heat exchange with saturated ammonia vapor 224 returning from the evaporator 130. An expansion valve 128 reduces the pressure of the subcooled liquid ammonia 222 so that it will evaporate at the temperature desired by the process operator. In practice, this temperature can range from 500° R to as low as 400° R. The selected temperature controls the operating pressure of the evaporator 130. For example, if the operator selects a temperature of 499° R, a temperature typical for storing fresh produce and cut flowers, the evaporator will operate at a pressure of about 70 psia. In the evaporator 130, most of the liquid ammonia evaporates, producing the refrigeration required by the heat load 330. A small fraction, preferably about 1% of the ammonia, passes through the evaporator 130 as a liquid to prevent accumulation of free water in the heat exchanger. The saturated ammonia vapor 224 is directed to the subcooler 126 where it is warmed (to about 541° R) by countercurrent heat exchange with the liquid ammonia 220 from the condenser 124.

4. Stripping Section of Distillation Column

The substantial process improvements result from the process steps in the non-adiabatic stripping section 120. The saturated ammonia-water liquid mixture 214 is directed by the manifold 116 to the fractionating channel of the non-adiabatic stripping section 120. The liquid mixture 214 flows downward over the heat and mass transfer surface, where it is heated by fluids flowing countercurrent in adjacent passages. The surface designs for heat and mass transfer zones may be of the same configuration as those described in U.S. Pat. No. 4,574,007, herein incorporated by reference. The surface serves the purpose of both extending heat transfer surface and structured packing. The ammonia is boiled away in successive stages until the liquid is nearly pure water, preferably containing less than 1% ammonia and boiling at a temperature of roughly 815° R.

Part of the thermal energy required to strip the ammonia from the water in the non-adiabatic stripping zone is delivered by a low pressure stream of hot waste gas 226. This is typically a low grade heat stream, such as the exhaust of a power generating system. For example, the exhaust of a modern recuperated microturbine, with efficiencies comparable to a Diesel engine, provides a hot waste gas stream at approximately 960° R. The hot waste gas 226 is cooled by flowing countercurrent to the liquid descending the column. In a preferred embodiment, the waste gas 226 is cooled to approximately 640° R. Remaining thermal energy in the cooled waste gas stream 238 can be directed to separate thermal recovery units 340 for further energy recovery.

More thermal energy for the separation is delivered by forcing the hot stripper bottoms liquid 228 to flow countercurrent to the liquid descending the column, in the same direction as the hot waste gas 226. In a preferred embodiment, the bottoms liquid is cooled to approximately 640° R. These two streams, the hot waste gas 226 and the hot stripper bottoms liquid 228, provide the thermal energy necessary to drive the reversible ammonia ARS.

5. Ejector

The cooled stripper bottoms liquid 230 enters an ejector 132, where the pressure is reduced from the stripping section 120 pressure to the evaporator 130 pressure. The high velocity of the water jet exiting the stripping section 118 will produce a mild pumping action, drawing the superheated ammonia vapor 232 into the ejector 132. Mixing of the liquid water and ammonia vapor cause the ammonia to be absorbed into the liquid, creating lean liquor 234.

6. Recuperator

The lean liquor 234 enters the recuperator 114, where it flows countercurrent with the rich liquor 210 exiting the absorber 110. Because of the heat of absorption, the lean liquor 234 will be well above that of the rich liquor 210 entering the recuperator 114. The heat of absorption is transferred to the rich liquor 210, further improving the efficiency of the process.

7. Phase Separator and Chiller

The lean liquor 234, which is a vapor-liquid mixture, is directed to a phase separator 134. Optionally, the phase separator 134 is part of the recuperator 114. The recuperator 114 inlet manifold can perform this function if designed to do so. Once the vapor 236 is separated, the liquid portion 238 of the lean liquor is further cooled in the lean liquor chiller 136 to assist in the process of completely absorbing the ammonia. The heat sink 336 for this step may have a further purpose in some applications of the process. For example, the heat sink may be used in the production of hot water, which may be particularly useful in large establishments such as hospitals or hotels. The lean liquor 234 is fed to the top of the absorber 110, and flows downward over the absorber packing. The vapor 236 is fed at the bottom of the column. A cooling coil 312 is connected to the heat sink 310 to ensure complete absorption of the ammonia. Optionally, some means of venting gases that are non-condensable are provided. Venting is rarely required, except after the system has been open to the atmosphere and a new refrigerant charge added. As an example, air that is introduced accidentally while charging the system with refrigerant mixture must be vented during the initial system start-up. The top of the absorber 110 is the preferred location for the vent 338.

Ammonia ARS Utilizing Non-Adiabatic Distillation and Recovered Heat of Absorption

The next level of improvement comes from addressing the heat of absorption, and finding a means to have that heat contribute to the binary mixture distillation. After being cooled in the stripping section of the column, the hot water is directed to an ejector, which draws in ammonia vapor coming from the evaporator. The resulting heat of absorption is transferred to the liquid mixture flowing down the column, thereby assisting the stripping of the ammonia from the liquid. The resulting ARS configuration produces approximately 3,000 BTUS of cooling for each 1,000 BTUs of thermal energy.

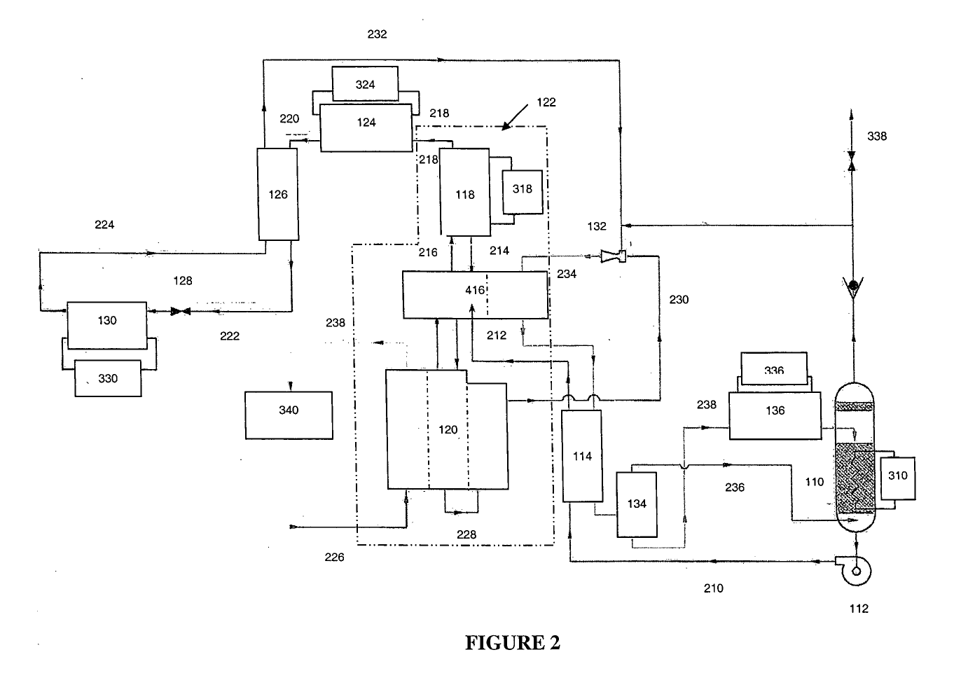

FIG. 2 is a basic process flow diagram of the second embodiment of the NAD ammonia ARS. The process steps are essentially the same as the first embodiment; however, the second embodiment contains a different component between the rectifying section 118 and the stripping section 120. In FIG. 1, this component is a manifold 116, which merely directs the liquid and vapor flow between the two column sections. In FIG. 2, this component is a fractionator/absorber 416 that includes a manifold, which manages the direction of the liquid and vapor streams. The fractionator/absorber 416 contains a mass transfer surface, in heat exchange relationship with the liquid flowing down the column. The 416 apparatus is sometimes called a NAD tray. The heat of absorption from the lean liquor 234 is transferred to the saturated rich liquor 212, resulting in a partial stripping of the ammonia from the liquid traveling down the column through the manifold. The lean liquor 234 reaches an equilibrium point at some temperature above that of the saturated rich liquor 210 feed temperature, and the lean liquor 234 absorbs the maximum amount of ammonia it can at that temperature. In one embodiment, this temperature is approximately 650° R.

Non-Adiabatic Distillation Internal Column Arrangement

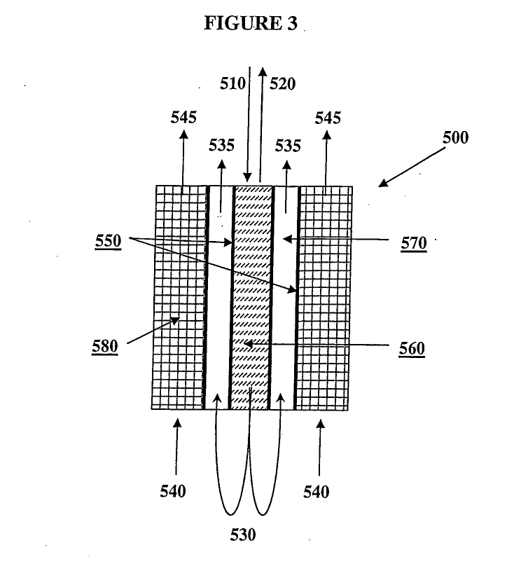

The stripping section 118 of the column in both embodiments is the focal point for thermal recovery. The column is internally configured to provide surfaces for efficient heat and mass transfer. FIG. 3 is a simple schematic for a suitable internal arrangement of the stripping section 118 of the column. In this embodiment, the column may be an assembly of one or more groups of five channels 500. The overall design of the of the stripping section has both a thermodynamic purpose and a mechanical purpose. The geometry of a single heat and mass transfer array used in the stripping section of a binary distillation column is shown in FIG. 3. The column is made up of multiple layers of this particular geometrical array. Generally, in this particular array configuration, heat is transferred from the hot gas stream to the hot bottoms liquid, averaging the thermal contribution of both streams to the process. This array can also be constructed in the configuration of concentric cylindrical pipes. Alternate refrigerants, such as carbon dioxide-water binary, would operate at much higher pressures, making a concentric cylinder configuration an attractive alternative.

The fractionating channel 560 is in the center. The feed liquid 510 flows downward through the fractionating channel and exits as heated bottoms liquid 530. An overhead vapor stream 520 flows upward as the feed is distilled.

On both sides of the fractionating channel 560 are channels 570 for the bottoms liquid. A thin parting sheet 550, or flat plate, separates the heat and mass transfer channels. The bottoms liquid 530 may be withdrawn from the fractionating channel 560 in any number of ways, including slots, perforations or other satisfactory turnaround methods. An external header should not be necessary for the column bottoms. The bottoms liquid is then forced to flow upward, countercurrent with the down-coming liquid feed 510, and exits as cooled liquid stream 535.

On the other side of the bottoms liquid channel 570, again separated by a parting sheet, are the hot gas passages 580. These should be very large in frontal area as compared to the bottoms liquid channel, as turbines tend to be very sensitive about pressure drops on their exhaust side. The higher the allowable pressure drop on this stream, the more compact and less costly the non-adiabatic fractionating device becomes. The hot gas 540 is also flowing upward, countercurrent with the liquid feed 510, and exits as cooled gas stream 545. The resulting heat transfer path in this assembly flows from the hot waste gas, through the bottoms liquid, and into the fractionating channel 560. The total heat transferred is the sum of that available from the hot bottoms liquid and the turbine exhaust (or any other waste gas stream).

The bottoms liquid, primarily water, has a very high specific heat as well as a high density. It does not, as it is being cooled in the apparatus, undergo a phase change. The waste gas stream often comes from an external device, such as a recuperated turbine. Control systems and load variations will cause momentary variations in temperature of this stream beyond the control of the refrigeration system. The heat recovery from the fractionating channel bottoms, when arranged in the manner shown in FIG. 3, also serves as a process modulator. The thermal transport properties will damp out process upsets and internal pinch points in the mass transfer channel that might be caused by momentary upsets in the hot waste gas stream.

Liquid/Vapor Distribution in the Manifold

When designing the internal configuration of the column and specifying flow rates, the operator should consider certain elements to ensure good system performance, such as good mixing of the liquid and vapor streams. In addition, excessive vapor velocity must be avoided, as it can result in liquid entrainment. Some mixtures also exhibit foaming characteristics when either liquid or vapor rates are out of the practical operating envelope.

The manifold component in both embodiments must be configured so as to promote suitable liquid distribution at the feed point. Not only is good distribution at the liquid feed point important, the distribution mechanism should be capable of deployment at regular intervals along the length of a tall fractionating device at minimal expense for redistribution purposes. FIG. 4 illustrates one suitable configuration 600 which permits a small liquid head to build and flow in a reasonably uniform manner through the small orifices 630 in plate 610. The liquid is allowed to build up to an arbitrary height above the distributor orifices 630. As the tubes 620 for gas flow present so much more free flow area, gas will not attempt to overcome the liquid head and cause flooding in the upper sections. Gas may then pass through the manifold and into the upper section through orifices 640. The tubes may be of any cross-sectional shape or size which allows for uniform and stable flow, for example, a circular or square cross-section.

In some operations, the configuration in FIG. 4 may cause structural problems due to relatively high pressures exerted against the flat plate separating the mass transfer channel from the heat transfer passes. To prevent such structural problems, alternate configurations may be used. For example, perforated sheet metal channels may be stacked above the seal bar, and flat plate support may be provided by tension members without interfering greatly with either liquid or vapor flow.

Multiple Evaporators

The refrigeration system may be constructed so as to accommodate multiple evaporators, thereby providing refrigeration at several different temperatures. For example, the ARS may provide the necessary refrigeration for an air conditioning system while providing refrigeration at a lower temperature for displaying frozen foods. In locations where people might be working or food might be stored, a barrier fluid or cascade system may be utilized to isolate the ammonia from enclosed areas. This barrier liquid may be, for example, liquid carbon dioxide. Liquid CO₂ is widely used as an expendable refrigerant for freezing and transporting food, and is readily available in most parts of the world. The liquid storage tank of the cascade system also serves as a backup system for food preservation during a disaster, when power systems become inoperative.

Uses for the ARS System

NAD is better suited for gas turbine exhaust heat sources than the conventional column. In the case of recuperated microturbine applications, which have an exhaust temperature of about 270° C., classical ammonia systems are able to convert a ΔT of only 90° C. of this low grade thermal energy to refrigeration. The NAD approach increases the convertible ΔT to 190° C. Ammonia absorption refrigeration systems utilizing NAD produce over four times the refrigeration per BTU of heat input than the classic ammonia absorption system. In the case of a condensing heat source, ammonia absorption refrigeration systems using NAD produce more than twice the refrigeration than the conventional system.

In addition to turbine exhaust, any source of thermal energy that is available at temperatures above 180° C. is suitable for the disclosed NAD. For example, engines of any description, industrial furnaces, foundries, and refineries.

I claim:

1. A column for non-adiabatic distillation of a mixture of two or more components comprising:
a feed inlet;
a stripping section comprising:
one or more fractionating channels suitable for separating the components of the mixture into a vaporized portion and a bottoms liquid portion;
one or more heat transfer channels; and
means for transferring the bottoms liquid from the one or more fractionating channels to the one or more heat transfer channels; and
a rectifying section.

2. The column of claim 1 wherein the bottoms liquid flows through the one or more heat transfer channels.

3. The column of claim 1 wherein hot gas flows through the one or more heat transfer channels.

4. The column of claim 1 wherein the hot gas is low-grade waste heat.

5. The column of claim 1 wherein bottoms liquid and hot gas flow separately through the one or more heat transfer channels.

6. The column of claim 4 wherein the bottoms liquid and hot gas flow countercurrent with the mixture.

7. The column of claim 1 wherein the one or more fractionating channels and the one or more heat transfer channels are concentric ducts.

8. The column of claim 6 wherein the bottoms liquid flows in the one or more heat transfer channels surrounding the one or more fractionating channels and the hot gas flows in the one or more heat transfer channels surrounding the one or more heat transfer channels containing the bottoms liquid.

9. The column of claim 1 wherein the fractionating channels and the heat transfer channels are separated by parting sheets.

10. The column of claim 1 wherein the rectifying section is equipped with a condenser wherein the condenser condenses the vaporized portion into a liquid.

11. The column of claim 1 further comprising a manifold separating the rectifying section and the stripping section.

12. The column of claim 10 wherein the manifold is located at the feed inlet.

13. The column of claim 10 wherein the manifold further comprises a mass transfer surface.

14. The column of claim 12 wherein the manifold further comprises a heat transfer surface.

15. A system for producing refrigeration from a composition comprising vapor and liquid components comprising:
an absorber;
a column for non-adiabatic distillation of a mixture of two or more components comprising:
a feed inlet;
a stripping section comprising:
one or more fractionating channels suitable for separating the components of the mixture into a vaporized portion and a bottoms liquid portion;
one or more heat transfer channels; and
means for transferring the bottoms liquid from the one or more fractionating channels to the one or more heat transfer channels;
a rectifying section; and
a manifold separating the rectifying section and the stripping section;
a condenser; and
one or more evaporators.

16. The system of claim 14 wherein the vapor component is ammonia and the liquid component is water.

17. The system of claim 14 wherein the bottoms liquid flows through the one or more heat transfer channels.

18. The system of claim 14 wherein hot gas flows through the one or more heat transfer channels.

19. The system of claim 14 wherein the hot gas is low-grade waste heat.

20. The system of claim 14 wherein bottoms liquid and hot gas flow separately through the one or more heat transfer channels.

21. The system of claim 18 wherein the bottoms liquid and hot gas flow countercurrent with the mixture.

22. The system of claim 14 wherein the one or more fractionating channels and the one or more heat transfer channels are concentric ducts.

23. The system of claim 20 wherein the bottoms liquid flows in the one or more heat transfer channels surrounding the one or more fractionating channels and the hot gas flows in the one or more heat transfer channels surrounding the one or more heat transfer channels containing the bottoms liquid.

24. The column of claim 14 wherein the fractionating channels and the heat transfer channels are separated by parting sheets.

25. The system of claim 14 further comprising a manifold separating the rectifying section and the stripping section.

26. The system of claim 23 wherein the manifold is located at the feed inlet.

27. The system of claim 23 wherein the manifold further comprises a mass transfer surface.

28. The system of claim 23 wherein the manifold further comprises a heat transfer surface.

29. The system of claim 14 wherein the condenser condenses the vaporized portion of the mixture into a liquid.

30. The system of claim 27 further comprising a subcooler, wherein the subcooler cools the liquid to produce a subcooled liquid at a specified temperature.

31. The system of claim 28 further comprising an expansion valve wherein the expansion valve reduces the pressure of the subcooled liquid.

32. The system of claim 29 wherein the evaporator evaporates the subcooled liquid to form a saturated vapor.

33. The system of claim 30 wherein the liquid is cooled in the subcooler by flowing countercurrent with the saturated vapor.

34. The system of claim 31 further comprising an ejector.

35. The system of claim 32 wherein the ejector mixes the bottoms liquid exiting the one or more heat transfer channels in the stripping section and the superheated vapor exiting the subcooler to produce a liquid-vapor mixture.

36. The system of claim 33 further comprising a recuperator, wherein the column feed is heated in the recuperator by flowing countercurrent with the liquid-vapor mixture from the ejector.

37. The system of claim 31 wherein the liquid-vapor mixture from the ejector is used to heat the mixture as it flows through the manifold.

38. The system of claim 32 further comprising a recuperator, wherein the liquid-vapor mixture is further used to heat the feed stream.

39. The system of claim 30 further comprising a phase separator, wherein the phase separator divides the liquid-vapor mixture into a liquid phase and a vapor phase.

40. The system of claim 34 further comprising a liquid chiller suitable for cooling the liquid phase.

41. A manifold for use in a distillation column comprising:
a flat plat comprising one or more holes; and
one or more tubes interspersed between the one or more holes;
wherein the one or more tubes have a greater cross-sectional area than the one or more holes.

42. The manifold of claim 39 wherein the tubes have a circular cross-section.

43. The manifold of claim 39 wherein the tubes have a square cross-section.

44. The manifold of claim 39 wherein the ratio of cross-sectional areas is 0:0.

45. A method for non-adiabatic distillation of a mixture of two or more components comprising:
feeding the mixture into the manifold section of a distillation column;
directing the vapor portion to the rectifying section of the column;
directing the liquid portion to one or more fractionating channels of the stripping section of the column;
transferring the bottoms liquid from the fractionating channel to one or more adjacent heat transfer channels;
forcing the bottoms liquid to flow countercurrent to the liquid feed;
feeding hot gas into one or more adjacent heat transfer channels such that it flows countercurrent with the liquid feed;
wherein the heat transfer path is from the hot gas to the bottoms liquid to the liquid mixture in the fractionating channel.
